(19) United States
(12) Patent Application Publication
(10) Pub. No.: US 2017/0117802 A1
(43) Pub. Date: Apr. 27, 2017

(54) CIRCUIT FOR INCREASING BUCK OUTPUT VOLTAGE

(71) Applicant: JOULWATT TECHNOLOGY (HANGZHOU) CO., LTD., Hangzhou (CN)

(72) Inventors: Junming ZHANG, Hangzhou (CN); Kunhui LUO, Hangzhou (CN); Yiqing JIN, Hangzhou (CN); Yuancheng REN, Hangzhou (CN); Biliang HUANG, Hangzhou (CN); Xunwei ZHOU, Hangzhou (CN)

(73) Assignee: JOULWATT TECHNOLOGY (HANGZHOU) CO., LTD., Hangzhou (CN)

(21) Appl. No.: 15/287,749

(22) Filed: Oct. 7, 2016

(30) Foreign Application Priority Data
Oct. 27, 2015 (CN) 201510708732.0

(51) Int. Cl. H02M 3/07

(52) U.S. Cl. CPC H02M 3/07

(57) ABSTRACT

A circuit includes a power supply end, a switching tube and a first loop connected to the power supply end in order, a second loop, and a load. The power supply end provides an input voltage for the circuit through a positive busbar and a negative busbar. The first loop includes a first capacitor, a first inductor, and a first freewheeling diode. When the switching tube is on, the first inductor is charged by the input voltage through the first capacitor; and when the switching tube is off, the first inductor discharges through the first capacitor and the first freewheeling diode. The second loop includes a second inductor coupled with the first inductor, a second capacitor and a second freewheeling diode forming a loop with the second inductor. The second capacitor and the first capacitor are connected in series.

### CROSS-REFERENCE TO RELATED APPLICATIONS

This Non-provisional application claims priority under 35 U.S.C. §119(a) on Patent Application No(s). 201510708732.0 filed in People's Republic of China on Oct. 27, 2015, the entire contents of which are hereby incorporated by reference.

### BACKGROUND OF THE INVENTION

Field of the Invention

The present invention relates to a buck circuit and, more particularly, to a circuit for increasing a buck output voltage.

Description of the Related Art

LED lighting has been more and more widely used because of the excellent energy saving performance. To satisfy the power grid working voltages in different nations and avoid the serious power grid harmonic pollution caused by a capacitive filter at an input end, an LED drive power supply with a good constant current effect, a high power factor, and current harmonics meeting the corresponding harmonic standard is required in an input voltage within a wide range of 100-264Vac.

In order to meet the requirements of the harmonics and the high power factor, the LED drive power supply usually needs a power factor correction circuit. The conventional power factor correction circuit usually adopts a boost circuit. However, generally the output voltage thereof is too high to be applicable. Therefore, a step-down circuit such as a buck circuit is adopted for the power factor correction circuit in recent years. There are two methods for the existing buck circuit to achieve the power factor correction. One is constant on time control working in a critical continuous conduction mode, and the other is peak current control working in the critical continuous conduction mode. The two control modes can meet the corresponding harmonic standard in the application of a low output voltage.

However, in the case of a high output voltage application, due to the limit of the working principle of the buck circuit, the input voltage is required to be higher than the output voltage, so that the buck circuit can work normally. At that time, a conduction angle in a line cycle gradually becomes smaller with the increase of the output voltage. As shown in FIG. 1, with the increase of the output voltage within one line cycle, the conduction angle is decreasing gradually. The decrease of the conduction angle will cause an input current harmonic to become higher, which is hard to meet the current harmonic standard.

### BRIEF SUMMARY OF THE INVENTION

To solve the problem that with the increase of an input voltage, a conduction angle within one line cycle decreases causing an input current harmonic to become higher in the existing buck circuit, the present invention provides a circuit for increasing the buck output voltage, which can increase the output voltage and increase the conduction angle within one line cycle at the same time.

To achieve the above objective, the present invention provides a circuit for increasing the buck output voltage, including a power supply end, a switching tube and a first loop connected to the power supply end in order, a second loop, and a load. The power supply end provides an input voltage for the circuit through a positive busbar and a negative busbar. The first loop includes a first capacitor, a first inductor, and a first freewheeling diode. When the switching tube is on, the first inductor is charged by the input voltage through the first capacitor; and when the switching tube is off, the first inductor discharges through the first capacitor and the first freewheeling diode. The second loop includes a second inductor coupled with the first inductor, a second capacitor and a second freewheeling diode forming loop with the second inductor. The second capacitor and the first capacitor are connected in series. When the switching tube is off and the first inductor is discharging, the second inductor generates a coupling voltage and discharges through the second loop. The load is connected between a positive terminal of the first capacitor and a negative terminal of the second capacitor.

According to one embodiment of the invention, the first inductor may charge the first capacitor when discharging. A voltage between two plates of the first capacitor may be proportional to the number of turns of the first inductor. The second inductor may charge the second capacitor when discharging. A voltage between two plates of the second capacitor may be proportional to the number of turns of the second inductor. The number of the turns of the first inductor may be larger than the number of the turns of the second inductor.

According to one embodiment of the invention, the switching tube may be connected to the negative busbar of the circuit, and the first freewheeling diode may be reversely connected between the positive busbar and the switching tube.

According to one embodiment of the invention, the switching tube may adopt a floating driver, the switching tube may be connected to the positive busbar of the circuit, and the first freewheeling diode may be reversely connected between the switching tube and the negative busbar.

According to one embodiment of the invention, both the first capacitor and the second capacitor may be electrolytic capacitors.

According to one embodiment of the invention, the circuit for increasing the buck output voltage may further include a bridge rectifier circuit disposed at the power supply end and rectifying the input voltage.

According to one embodiment of the invention, the switching tube may be a metal-oxide-semiconductor field-effect transistor (MOSFET).

To sum up, compared with the prior art, the circuit for increasing the buck output voltage provided in the invention has the following advantages:

During the period when the switching tube is on, the input voltage charges the first inductor through the loop formed by the first capacitor, the first inductor, and the switching tube, while since the second freewheeling diode is cut off in the second loop, there is no current flowing in the second loop. When the switching tube is off, the first inductor discharges through the first loop formed by the first capacitor, the first inductor, and the first freewheeling diode. At the same time, the second inductor generates the coupling voltage, and the coupling voltage discharges through the second capacitor and the second freewheeling diode. When the switching tube is on, in view of an input side, the conduction angle in a line cycle is decided by the voltage between the two plates of the first capacitor. Since the output voltage is the sum of the voltage between the two plates of the first capacitor and the voltage between the two plates of the second capacitor, the voltage between the two plates of the first capacitor is lower than the output voltage. It can be concluded from the relationship between the voltage and the conduction angle that compared with the conventional buck circuit, when the output voltages are the same, the conduction angle at the input side is only decided by the voltage between the two plates of the first capacitor, and thus the buck circuit with the coupling inductors provided in the invention has a larger conduction angle in one line cycle. The sinusoid degree of the current can be effectively improved and the current harmonics can be reduced by the increase of the conduction angle.

These and other features, aspects, and advantages of the present invention will become better understood with regard to the following description, appended claims, and accompanying drawings.

### BRIEF DESCRIPTION OF THE DRAWINGS

FIG. 1 is a relationship diagram illustrating an input voltage, an output voltage and a conduction angle in the conventional buck circuit;

FIG. 2 is a principle diagram illustrating a circuit for increasing a buck output voltage according to one embodiment of the present invention;

FIG. 3 is a relationship diagram illustrating an input voltage, an output voltage, and a conduction angle of the circuit for increasing the buck output voltage as shown in FIG. 2; and

FIG. 4 is a principle diagram illustrating the circuit for increasing the buck output voltage according to another embodiment of the present invention.

### DETAILED DESCRIPTION OF THE INVENTION

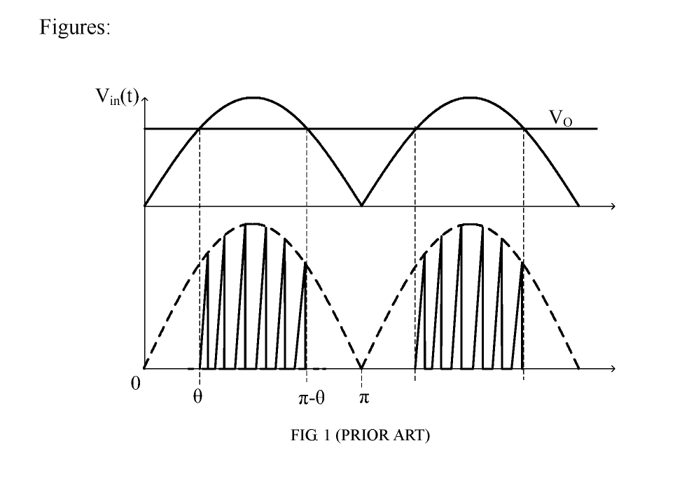

Due to the limit of the principle of a buck circuit, the input voltage thereof is required to be higher than the output voltage. As shown in FIG. 1, Vᵢₙ(t) is the input voltage, and Vₒ is the output voltage. Within the range of θ-(π-θ), the buck circuit works normally. θ is a starting angle when the buck circuit starts working normally, π-θ is a terminating angle when the buck circuit stops working normally, and π-2θ is a conduction angle when the buck circuit works normally. As shown in FIG. 1, the starting angle θ increases with the gradual increase of the output voltage, and correspondingly, the conduction angle π-2θ decreases significantly. In this kind of the circuit in a topological structure, the decrease of the conduction angle will cause harmonics of an input current to increase, which is hard to meet the corresponding harmonic standard finally.

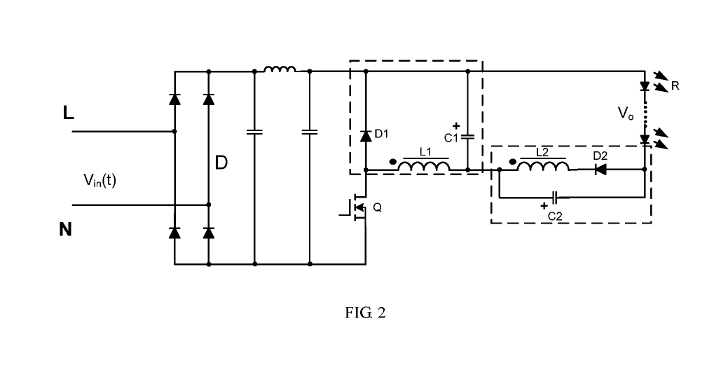

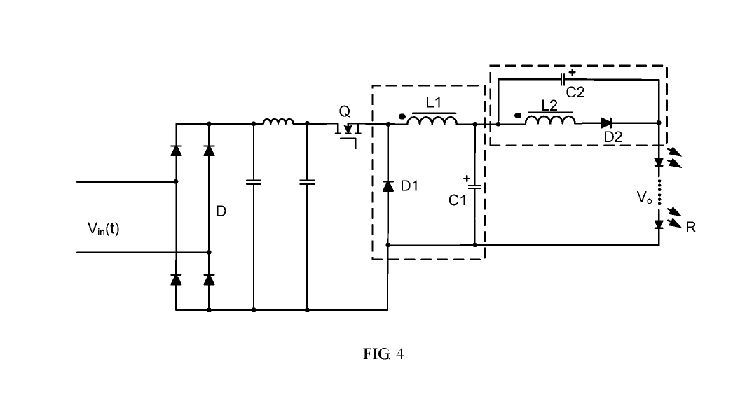

In view of this, in order to solve the problem, the present embodiment provides a circuit for increasing a buck output voltage, including a power supply end (the left end in FIG. 2 and FIG. 4), a switching tube Q and a first loop connected to the power supply end in order, a second loop, and a load R. The power supply end provides the input voltage for the circuit through a positive busbar and a negative busbar. The first loop includes a first capacitor C1, a first inductor L1, and a first freewheeling diode D1. When the switching tube Q is on, the first inductor L1 is charged by the input voltage through the first capacitor C1. When the switching tube Q is off, the first inductor L1 discharges through the first capacitor C1 and the first freewheeling diode D1. The second loop includes a second inductor L2 coupled with the first inductor L1, a second capacitor C2, and a second freewheeling diode D2 forming a loop with the second inductor L2. The second capacitor C2 and the first capacitor C1 are connected in series. When the switching tube Q is cut off and the first inductor L1 is discharging, the second inductor L2 generates a coupling voltage and discharges through the second loop. The load R is connected between a positive terminal of the first capacitor C1 and a negative terminal of the second capacitor C2.

The structures of the first loop and the switching tube are the same with those in the conventional buck circuit. The second loop formed by the coupling second inductor L2 is added on the base of the conventional buck circuit. During the period when the switching tube Q is on, the first inductor L1 is charged by the alternating current (AC) input voltage through the first capacitor C1. In the same time, the second freewheeling diode D2 in the second loop is cut off, and there is no current flowing through the second inductor L2. At that time, in view of an input side, the working conduction angle of the buck circuit is decided by the voltage U_{c1} between the two plates of the first capacitor C1.

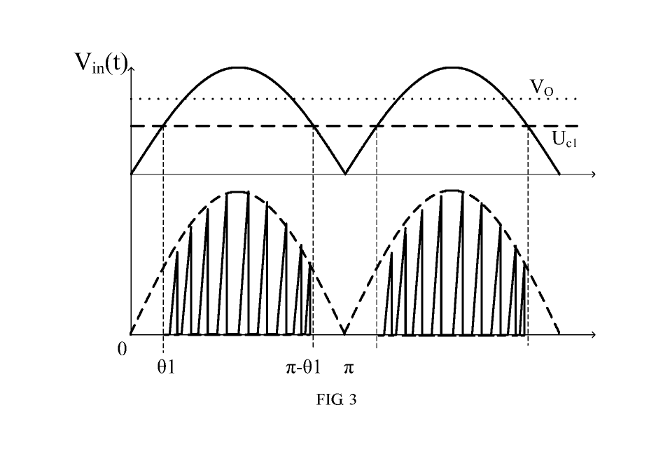

When the first inductor L1 is discharging through the first loop, the second inductor L2 generates the coupling voltage due to electromagnetic field coupling. The coupling voltage discharges through the second capacitor C2 and the second freewheeling diode D2 and charges the second capacitor C2. Since the first capacitor C1 and the second capacitor C2 are connected in series and the load R is connected to the positive terminal of the first capacitor C1 and the negative terminal of the second capacitor C2, the output voltage Vₒ output to the load R is the sum of the voltage U_{c1} between the two plates of the first capacitor C1 and the voltage U_{c2} between the two plates of the second capacitor C2, that is Vₒ=U_{c1}+U_{c2}. From the relationship, it can be seen that the voltage U_{c1} is definitely smaller than the output voltage Vo. The working conduction angle of the circuit for increasing the buck output voltage provided in the invention is decided by the voltage U_{c1} between the two plates of the first capacitor C1, and the voltage U_{c1} is smaller than the output voltage Vₒ. Therefore, referring to FIG. 1 and FIG. 3 together, compared with the conventional buck circuit, when the output voltages Vₒ are the same, the conduction angle of the circuit for increasing the buck output voltage provided in the invention is larger. In other words, when the conduction angles are the same, the circuit for increasing the buck output voltage provided in the invention can have the higher output voltage. As shown in FIG. 3, θ1 is the starting angle when the circuit for increasing the buck output voltage starts working normally, and π-θ1 is the terminating angle when the circuit for increasing the buck output voltage stops working normally.

When the switching tube Q is off, the voltage U₁ between two ends of the first inductor U1 and the voltage U_{c1} between two plates the first capacitor C1 differ by a conduction voltage of the first freewheeling diode D1. The conduction voltage of the first freewheeling diode D1 is small, and it can be approximately regarded that U₁=U_{c1}. Similarly, when the second inductor L2 generates the coupling voltage and is discharging, the voltage U₂ between two ends of the second inductor L2 and the voltage U_{c2} between two plates the second capacitor C2 differ by a conduction voltage of the second freewheeling diode D2. The conduction voltage of the second freewheeling diode D2 is small, and it can be approximately regarded that U₂=U_{c2}. According to the voltage relationship between the coupling inductors U₁:U₂=N1:N2, that is U_{c1}:U_{c2}=N1:N2, the circuit for increasing the buck output voltage in the embodiment can control U_{c1} and U_{c2} by adjusting the number N1 of the turns of the first inductor L1 and the number N2 of the turns of the second inductor L2.

It can be seen from Vₒ=U_{c1}+U_{c2} that with the decrease of the value of U_{c1} (i.e., the number N1 of the turns of the first inductor L1 is getting small), the circuit for increasing the buck output voltage provided in the invention has a larger conduction angle, thereby further reducing the amount of the harmonics of the input current. However, in actual application, if the value of U_{c1} is too small, the circuit will work unstably. In view of this, in this embodiment, the number N1 of the turns of the first inductor L1 is larger than the number N2 of the turns of the second inductor L2. However, the invention is not limited thereto.

In the embodiment, the switching tube Q is a metal-oxide-semiconductor field-effect transistor (MOSFET), and both the first capacitor C1 and the second capacitor C2 are electrolytic capacitors. However, the invention is not limited thereto. In other embodiments, the switching tube Q may be a triode or a metal-oxide-semiconductor (MOS) tube in other types, and the first capacitor C1 and the second capacitor C2 may be capacitors in other types such as air-spaced capacitors.

In the embodiment, to facilitate the driving of the switching tube Q, the switching tube Q can be connected to the negative busbar of the circuit, and the first freewheeling diode D1 is reversely connected between the positive busbar and the switching tube Q. In this structure, since the source of the switching tube Q is connected to the negative busbar and the voltage V_{gs} of the switching tube Q is constant, the switching tube Q does not need to adopt a floating drive and the design structure of the circuit is greatly simplified. However, the invention is not limited thereto. In other embodiments, as shown in FIG. 4, the switching tube Q can be connected to the positive busbar of the circuit, and at that time, the first freewheeling diode D1 is reversely connected between the switching tube Q and the negative busbar. In this structure, since the source of the switching tube Q is connected to a cathode of the first freewheeling diode D1 and the voltage V_{gs} of the switching tube Q is inconstant, the floating driving is needed.

In the embodiment, the circuit for increasing the buck output voltage may further include a bridge rectifier circuit D disposed at the power supply end and rectifying the input voltage.

To sum up, during the period when the switching tube is on, the input voltage charges the first inductor through the loop formed by the first capacitor, the first inductor, and the switching tube, while since the second freewheeling diode is cut off in the second loop, there is no current flowing in the second loop. When the switching tube is off, the first inductor discharges through the first loop formed by the first capacitor, the first inductor, and the first freewheeling diode. At the same time, the second inductor generates the coupling voltage, and the coupling voltage discharges through the second capacitor and the second freewheeling diode. When the switching tube is on, in view of an input side, the conduction angle in a line cycle is decided by the voltage between the two plates of the first capacitor. Since the output voltage is the sum of the voltage between the two plates of the first capacitor and the voltage between the two plates of the second capacitor, the voltage between the two plates of the first capacitor is lower than the output voltage. It can be concluded from the relationship between the voltage and the conduction angle that compared with the conventional buck circuit, when the output voltages are the same, the conduction angle at the input side is only decided by the voltage between the two plates of the first capacitor, and thus the buck circuit with the coupling inductors provided in the invention has a larger conduction angle in one line cycle. The sinusoid degree of the current can be effectively improved and the current harmonics can be reduced by the increase of the conduction angle.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A circuit for increasing a buck output voltage, comprising:
a power supply end, providing an input voltage for the circuit through a positive busbar and a negative busbar;
a switching tube and a first loop connecting to the power supply end in order, the first loop comprising a first capacitor, a first inductor, and a first freewheeling diode, wherein when the switching tube is on, the first inductor is charged by the input voltage through the first capacitor, and when the switching tube is off, the first inductor discharges through the first capacitor and the first freewheeling diode;
a second loop, comprising a second inductor coupled with the first inductor, a second capacitor and a second freewheeling diode forming a loop with the second inductor, wherein the second capacitor and the first capacitor are connected in series, and when the switching tube is off and the first inductor is discharging, the second inductor generates a coupling voltage and discharges through the second loop; and
a load, connecting between a positive terminal of the first capacitor and a negative terminal of the second capacitor.

2. The circuit for increasing a buck output voltage according to claim 1, wherein the first inductor charges the first capacitor when discharging, a voltage between two plates of the first capacitor is proportional to the number of turns of the first inductor, the second inductor charges the second capacitor when discharging, a voltage between two plates of the second capacitor is proportional to the number of turns of the second inductor, and the number of the turns of the first inductor is larger than the number of the turns of the second inductor.

3. The circuit for increasing a buck output voltage according to claim 1, wherein the switching tube is connected to the negative busbar of the circuit, and the first freewheeling diode is reversely connected between the positive busbar and the switching tube.

4. The circuit for increasing a buck output voltage according to claim 1, wherein the switching tube adopts a floating drive, the switching tube is connected to the positive busbar of the circuit, and the first freewheeling diode is reversely connected between the switching tube and the negative busbar.

5. The circuit for increasing a buck output voltage according to claim 1, wherein both the first capacitor and the second capacitor are electrolytic capacitors.

6. The circuit for increasing a buck output voltage according to claim 1, further comprising a bridge rectifier circuit disposed at the power supply end and rectifying the input voltage.

7. The circuit for increasing a buck output voltage according to claim 1, wherein the switching tube is a metal-oxide-semiconductor field-effect transistor (MOSFET).
